(19) United States
(12) Patent Application Publication
(10) Pub. No.: US 2025/0208557 A1
(43) Pub. Date: Jun. 26, 2025

(54) IMAGE FORMING APPARATUS

(71) Applicant: CANON KABUSHIKI KAISHA, Tokyo (JP)

(72) Inventor: SATOSHI SUNAHARA, Tokyo (JP)

(21) Appl. No.: 18/988,237

(22) Filed: Dec. 19, 2024

(30) Foreign Application Priority Data
Dec. 20, 2023 (JP) 2023-214708

(51) Int. Cl. G03G 15/00

(52) U.S. Cl. CPC G03G 15/556

(57) ABSTRACT

An image forming apparatus includes: a pixel number obtainment portion that obtains, the number of printing pixels with brightness of the exposure that is at least a predetermined brightness among pixels within a predetermined image range; a specific pixel obtainment portion that obtains first pixel information and second pixel information, which relates to an integrated value of pixels having a difference in brightness of exposure that is at least a predetermined degree of difference relative to an adjacent pixel in a main scanning direction and a sub-scanning direction within a predetermined image range; a correction factor obtainment portion that obtains, on the basis of the first pixel information and the second pixel information, a correction factor for a toner consumption amount; and a consumption amount obtainment portion configured to correct and obtain a toner consumption amount by using the correction factor obtained by the correction factor obtainment portion.

### BACKGROUND OF THE INVENTION

### Field of the Invention

The present invention relates to an image forming apparatus that uses an electrophotographic system.

### Description of the Related Art

For image forming apparatuses using an electrophotographic system, many configurations have been proposed that include a remaining toner amount detection unit, which detects the amount of toner (developer) for development remaining in a toner container and which notifies a user of the amount. In recent years, configurations of the remaining toner amount detection unit have been increasingly proposed that count the toner consumption amount by counting the exposure patterns when forming electrostatic latent images, thereby detecting the amount of remaining toner without using a physical remaining toner detection unit.

For example, Japanese Patent Application Publication No. 2015-145969 discloses a method for counting, as horizontal edges or vertical edges, specific pixels among multiple pixels within an image range, and determining a correction amount for the toner consumption amount on the basis of information regarding the horizontal edges and vertical edges.

### SUMMARY OF THE INVENTION

However, even when the pixel count number is the same, the actual toner consumption amount may vary depending on the image content, such as a character image, a line image, a halftone image, a solid image, and the like. To avoid this, one method would be to add up the consumption amount for each pixel, but this would require complex and enormous image processing.

Also, the method disclosed in Japanese Patent Application Publication No. 2015-145969 uses the ratio of vertical edges to the sum of horizontal and vertical edges to limit variations in the consumption amount caused by the ratio of vertical and horizontal edges. As such, the method may fail to take into account the number of pixels counted in a predetermined region, hence the variations in image patterns are not sufficiently considered.

An object of the present invention is to provide a technique that enables a toner consumption amount to be obtained easily and accurately.

To achieve the above object, an image forming apparatus of the present invention includes:
a photosensitive member;
a charging portion configured to charge the photosensitive member;
an exposure portion configured to perform exposure of a surface of the photosensitive member that is charged by the charging portion on the basis of image information, thereby forming an electrostatic latent image on the surface;
a developing portion configured to develop the electrostatic latent image with toner, thereby forming a toner image on the surface; and
a transfer portion configured to transfer the toner image to a recording material from the surface of the photosensitive member,
wherein the image forming apparatus includes:
a pixel number obtainment portion configured to obtain, from the image information, the number of printing pixels with brightness of the exposure that is at least a predetermined brightness among pixels within a predetermined image range;
a specific pixel obtainment portion configured to obtain first pixel information and second pixel information, the first pixel information being pixel information using an integrated value of the number of pixels having a difference in brightness of the exposure that is at least a predetermined degree of difference relative to an adjacent pixel in a main scanning direction within the predetermined image range, and the second pixel information being pixel information using an integrated value of the number of pixels having a difference in the brightness that is at least a predetermined degree of difference relative to an adjacent pixel in a sub-scanning direction within the predetermined image range;
a correction factor obtainment portion configured to obtain, on the basis of the first pixel information and the second pixel information, a correction factor for a toner consumption amount based on brightness of the exposure; and
a consumption amount obtainment portion configured to correct and obtain a toner consumption amount based on brightness of the exposure by using the correction factor obtained by the correction factor obtainment portion.

According to the present invention, it is possible to easily and accurately obtain a toner consumption amount.

Further features of the present invention will become apparent from the following description of exemplary embodiments with reference to the attached drawings.

### BRIEF DESCRIPTION OF THE DRAWINGS

FIGS. 1A to 1G are explanatory diagrams of vertical edge counts and horizontal edge counts in a first embodiment;

FIG. 2 is a schematic cross-sectional view of an image forming apparatus according to an embodiment of the present invention;

FIG. 3 is a block diagram of a control configuration of the image forming apparatus according to an embodiment of the present invention;

FIG. 4 is a diagram showing one image pattern to which the first embodiment is specifically applied;

FIG. 5 is a diagram showing one image pattern to which another example of the first embodiment is specifically applied;

FIGS. 6A to 6H are explanatory diagrams of vertical edge counts and horizontal edge counts in a second embodiment;

FIG. 7 is a diagram showing one image pattern to which the second embodiment is specifically applied;

FIG. 8 is a diagram showing one image pattern to which another example of the second embodiment is specifically applied;

FIG. 9 is a diagram showing one image pattern to which yet another example of the second embodiment is specifically applied;

FIGS. 10A and 10B are diagrams showing Tables 1 and 2;

FIG. 11 is a diagram showing Table 3;

FIGS. 12A and 12B are diagrams showing Tables 4 and 5;

FIG. 13 is a diagram showing Table 6;

FIG. 14 is a diagram showing Table 7; and

FIG. 15 is a diagram showing Table 8.

### DESCRIPTION OF THE EMBODIMENTS

Referring to the drawings, exemplary modes for carrying out the present invention will be described in detail using embodiments. However, the dimensions, materials, shapes, and relative arrangements of the components described in the embodiments may be modified as appropriate according to the configuration of the apparatus to which the invention is applied and various conditions. Also, not all combinations of features described in the present embodiments are essential for the solution means of the invention. That is, the description is not intended to limit the scope of the present invention to the following embodiments.

### First Embodiment

### Overall Configuration of Image Forming Apparatus

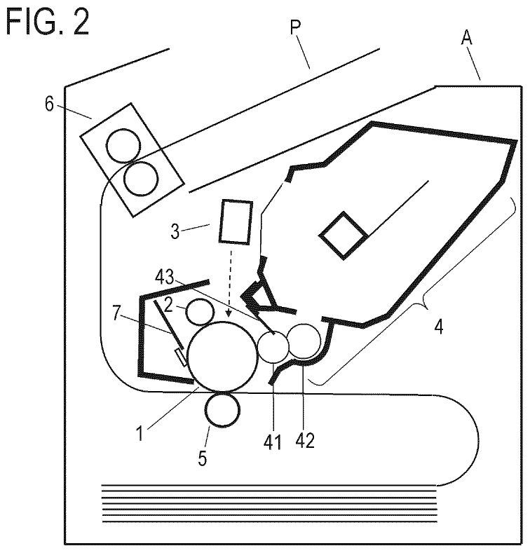

Referring to FIG. 2, the overall configuration of the image forming apparatus according to a first embodiment of the present invention is now described. FIG. 2 is a schematic cross-sectional view of the image forming apparatus according to this embodiment. Image forming apparatuses to which the present invention is applicable include image forming apparatuses that use an electrophotographic recording system, such as laser printers, copying machines, and facsimiles.

The image forming apparatus A according to this embodiment includes a photosensitive drum 1, a charging roller 2, an exposure apparatus 3, a developing apparatus 4, a transfer roller 5, and a fixing apparatus 6. The charging roller 2 forms a charging apparatus (charging portion) for charging the surface of the photosensitive drum 1 in the image forming apparatus A. The exposure apparatus 3 is an exposure portion for performing exposure of the surface of the photosensitive drum 1 on the basis of exposure information corresponding to image data (image information) in order to form an electrostatic latent image on the charged photosensitive drum 1 corresponding to the image data. The developing apparatus 4 is a developing portion for developing the electrostatic latent image formed on the surface of the photosensitive drum 1 with toner (developer) T to form a toner image on the surface of the photosensitive drum 1. The transfer roller 5 sandwiches a recording material P between the transfer roller 5 and the photosensitive drum 1 and forms a transfer apparatus (transfer portion), which transfers the toner image to the recording material P from the photosensitive drum 1. The fixing apparatus 6 is a fixing portion that heats and presses the recording material P to fix the toner image onto the recording material P. Also, a power supply (not shown) is attached to the image forming apparatus A to apply a predetermined voltage to each of the charging roller 2, the developing apparatus 4, the transfer roller 5, and the like. The photosensitive drum 1 is an image bearing member, in which a negatively charged organic photosensitive member is formed on a tubular cylinder. The photosensitive drum 1 has a diameter of 24 mm and is driven and rotated by a motor in a predetermined direction (clockwise direction in the figure) at a predetermined process speed. The photosensitive drum 1 in this embodiment is rotated at a process speed of 250 mm/sec.

The charging roller 2, to which a desired charging voltage is applied by a power supply (not shown), is a charging member that is in contact with the rotating photosensitive drum 1 with a predetermined contact pressure, and uniformly charges the surface of the photosensitive drum 1 to a predetermined potential. In this embodiment, the photosensitive drum 1 is negatively charged by the charging roller 2. The potential charged by the charging roller 2 is referred to as a dark potential.

The exposure apparatus 3 is an exposure unit for performing exposure corresponding to image information input from an external device or a reading apparatus. Examples of the exposure apparatus 3 include a scanner unit that scans the surface of the photosensitive drum 1 with a semiconductor laser, and an LED exposure apparatus having an LED array in which multiple LEDs are arranged along the longitudinal direction of the photosensitive drum 1. In this embodiment, a scanner unit that performs scanning with a semiconductor laser is used as the exposure apparatus 3. Also, when the surface of the photosensitive drum 1 having a dark potential is exposed by the exposure apparatus 3, the surface potential of the photosensitive drum 1 attenuated to near the ground potential is referred to as a bright potential. In other words, an image portion, which is formed by performing exposure with a predetermined light amount to have a bright potential for actively attracting toner, and a non-image portion, which is not exposed, are formed on the photosensitive drum 1 corresponding to the image information. This forms what is known as an electrostatic latent image. In some cases, the non-image portion may be formed to have a potential that does not actively attract toner by exposing the non-image portion to a second amount of light that is less than a first amount of light used to expose the image portion.

The developing apparatus 4 is a developing unit including a developing roller 41, which serves as a developer bearing member for bearing developer, a developer container, which serves as the frame of the developing apparatus 4, a supply roller 42, which can supply developer to the developing roller 41, and a developing blade 43, which regulates the amount of developer. The developer container rotationally supports the developing roller 41 and the supply roller 42. The developing roller 41 is arranged at the opening of the developer container so as to face the photosensitive drum 1. The supply roller 42 is rotationally in contact with the developing roller 41, and the toner contained in the developer container as a developer is applied onto the surface of the developing roller 41 by the supply roller 42. The developing blade 43 is an elastic member, and is in contact with the developing roller 41 while being bent against elasticity. The developing blade 43 causes the toner borne on the surface of the developing roller 41 to have a predetermined layer thickness, and the toner is conveyed to the developing portion facing the photosensitive drum 1.

The developing apparatus 4 of this embodiment uses a contact development system as the development system. That is, the toner layer borne by the developing roller 41 bearing the toner comes into contact with the photosensitive drum 1 in the developing portion (developing region) in which the photosensitive drum 1 and the developing roller 41 face each other. A developing voltage is applied to the developing roller 41 by a power supply (not shown). Under the developing voltage, the toner borne by the developing roller 41 is transferred from the developing roller 41 to the surface of the photosensitive drum 1 according to the potential on the surface of the photosensitive drum 1, thereby developing the electrostatic latent image on the photosensitive drum into a toner image.

In one example, the toner in this embodiment may be polymerized toner that is produced by a polymerization method, spherical in shape with a particle size of 7 μm, and has a normal charging polarity of negative polarity. Also, the toner in this embodiment does not contain a magnetic component, and is what is known as a non-magnetic one-component developer with which the toner is borne on the developing roller 41 mainly by intermolecular forces and electrostatic force (image force). Furthermore, in addition to toner particles, one-component developer may contain additives (for example, wax or silica fine particles) for adjusting the fluidity and charging performance of the toner. It should be noted that the developer may also be a magnetic one-component developer containing a magnetic component, or a two-component developer composed of a non-magnetic toner and a magnetic carrier. When a magnetic developer is used, the developer bearing member may be a cylindrical developing sleeve having a magnet therein.

The transfer roller 5, to which a transfer voltage is applied from a power supply (not shown), is a transfer member that transfers the toner image borne by the photosensitive drum 1 to a recording material P. The recording material P to which the toner image is transferred is conveyed to the fixing apparatus 6.

The fixing apparatus 6 is a fixing unit of a thermal fixing type that performs fixing processing of an image by heating and melting the toner on the recording material P. The fixing apparatus 6 includes a fixing film, a fixing heater such as a ceramic heater for heating the fixing film, a thermistor for measuring the temperature of the fixing heater, and a pressure roller for pressing against the fixing film. After passing through the fixing apparatus 6, the recording material P is discharged to the outside of the image forming apparatus A (outside of the apparatus) by a pair of discharge rollers as a discharging member and loaded onto a discharge tray as a loading portion formed in the upper part of the printer main body.

Meanwhile, the developer remaining on the photosensitive drum 1 without being transferred is removed from the photosensitive drum by a cleaning apparatus 7 arranged downstream of the transfer roller 5 in the rotation direction of the photosensitive drum, and is accumulated in the cleaning apparatus 7. The cleaning apparatus 7 may have various configurations. In this example, what is known as a cleaning blade configuration is used in which urethane rubber supported and fixed on a metal plate is brought into contact with the photosensitive drum in the counter direction to the rotation direction.

### Image Signal Processing Portion, Control Portion, Laser Driving Portion, Calculation Portion

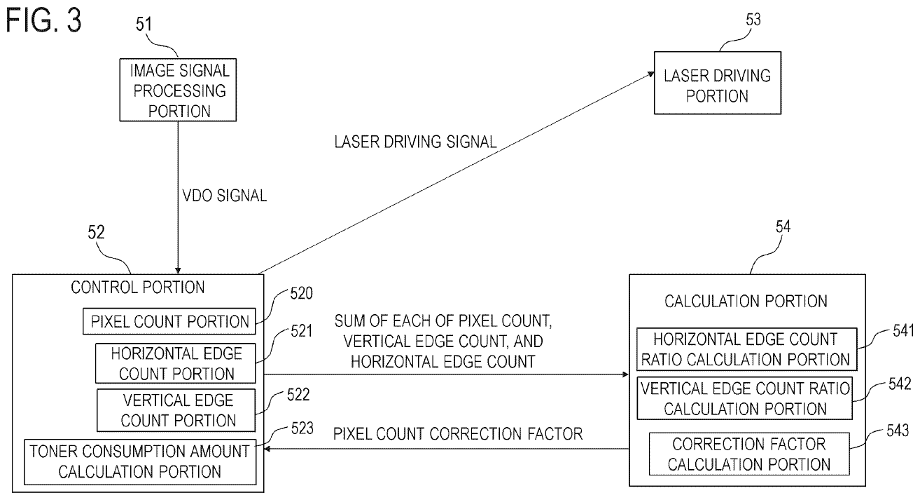

FIG. 3 is a block diagram showing a control configuration relating to image formation of the image forming apparatus A. The control configuration includes an image signal processing portion 51, a control portion 52, a laser driving portion 53, and a calculation portion 54.

The image signal processing portion 51 receives printing information from a host computer (not shown), and generates a VDO signal corresponding to the printing information. The VDO signal is a signal for controlling the emission and extinction of laser light from a semiconductor laser. The control portion 52 controls the image forming apparatus A and counts the presence or absence of pixels in the VDO signal. More specifically, the control portion 52 converts the VDO signal into a laser driving signal, converts the VDO signal into pixel count information, and performs vertical edge counting and horizontal edge counting. The laser driving portion 53 controls the emission and extinction of the laser light from the semiconductor laser on the basis of the laser driving signal converted from the VDO signal, and forms a latent image on the scanned surface of the photosensitive drum 1, which is charged in advance.

The control portion 52 includes a pixel count portion 520 as a pixel number obtainment portion. The pixel count portion 520 obtains, from the VDO signal as image information, the number of pixels (printing pixels) for which the concentration of the toner to be applied is greater than or equal to a predetermined concentration among the pixels (picture elements) within the range in which an image can be formed on one recording material as a predetermined image range.

The control portion 52 also includes a horizontal edge count portion 521 and a vertical edge count portion 522 as a specific pixel obtainment portion. In addition to the above-mentioned counting of the presence or absence of pixels in the VDO signal using the pixel count portion 520, the control portion 52 performs the following processing using the horizontal edge count portion 521 and the vertical edge count portion 522.

That is, when a certain one pixel satisfies the condition that there is a brightness difference greater than or equal to a given degree relative to a pixel adjacent in the main scanning direction, the horizontal edge count portion 521 counts this pixel as having a horizontal edge. More specifically, the horizontal edge count portion 521 counts, among the pixels with exposure brightness that is greater than or equal to a predetermined value (printing pixels), a pixel having a difference in exposure brightness that is greater than or equal to a predetermined degree of difference relative to an adjacent pixel in the main scanning direction as a pixel having a horizontal edge. Similarly, when a certain one pixel satisfies the condition that there is a brightness difference greater than or equal to a given degree relative to a pixel adjacent in the sub-scanning direction, the vertical edge count portion 522 counts this pixel as having a vertical edge. More specifically, the vertical edge count portion 522 counts, among the pixels with exposure brightness that is greater than or equal to a predetermined value (printing pixels), a pixel having a difference in exposure brightness that is greater than or equal to a predetermined degree of difference relative to an adjacent pixel in the sub-scanning direction as a pixel having a vertical edge.

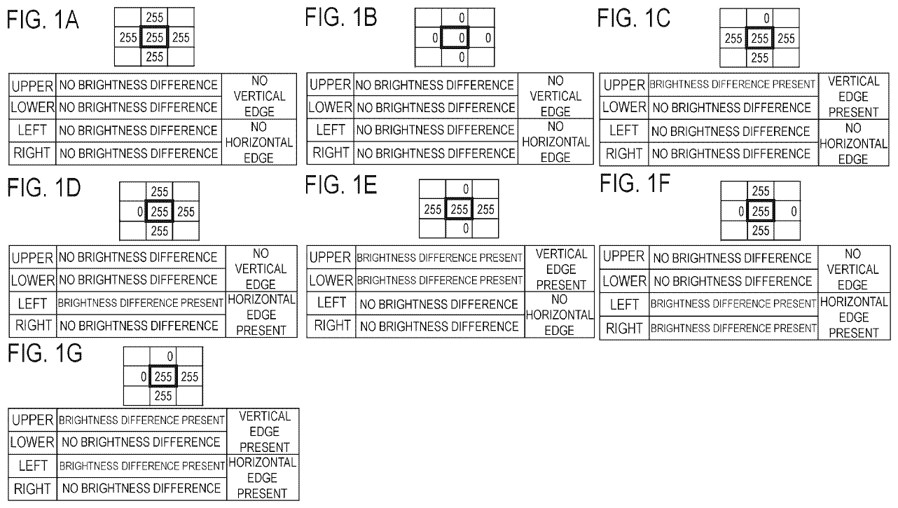

This operation is now described using FIGS. 1A to 1G. It should be noted that a pixel may have a value of 256 gradations ranging from 0 to 255, and an edge is determined to be present when the difference between adjacent brightness values is greater than or equal to 240.

In each of FIGS. 1A to 1G, the pixel of interest is the pixel enclosed by a heavy line.

In FIG. 1A, the brightness value of the pixel of interest is 255, and the adjacent pixels on the upper, lower, left, and right sides are also 255, so that the brightness difference between them is 0. Neither vertical nor horizontal edges are counted.

In FIG. 1B, the brightness value of the pixel of interest is 0, and the adjacent pixels on the upper, lower, left, and right sides are also 0, so that the brightness difference between them is 0. Neither vertical nor horizontal edges are counted. In this embodiment, pixels with a brightness value of 0 are not counted as pixels with an edge, as will be described below.

In FIG. 1C, the brightness value of the pixel of interest is 255, the brightness value of the adjacent pixel on the upper side is 0, and the brightness values on the lower, left, and right sides are 255, so that a vertical edge is counted, and a horizontal edge is not counted.

In FIG. 1D, the brightness value of the pixel of interest is 255, the brightness value of the adjacent pixel on the left side is 0, and the brightness values on the upper, lower, and right sides are 255, so that a vertical edge is not counted, and a horizontal edge is counted.

In FIG. 1E, the brightness value of the pixel of interest is 255, the brightness values of the adjacent pixels on the upper and lower sides are 0, and the brightness values on the left and right sides are 255, so that a vertical edge is counted, and a horizontal edge is not counted. FIG. 1C has a brightness difference only on the upper side, while FIG. 1E has brightness differences on both upper and lower sides. However, the vertical edge count is equally 1.

In FIG. 1F, the brightness value of the pixel of interest is 255, the brightness values of the adjacent pixels on the right and left sides are 0, and the brightness values on the upper and lower sides are 255, so that a horizontal edge is counted, and a vertical edge is not counted. FIG. 1D has a brightness difference only on the left side, while FIG. 1F has brightness differences on both left and right sides. However, the horizontal edge count is equally 1.

In FIG. 1G, the brightness value of the pixel of interest is 255, the brightness values of the adjacent pixels on the upper and left sides are 0, and the brightness values on the lower and right sides are 255, so that a vertical edge and a horizontal edge are counted.

By repeating these steps, within a predetermined unit of printing information (for example, one sheet of paper to be printed), the control portion 52 calculates (obtains):
Sum of VDO signal counts (hereinafter referred to as pixel count information);
Sum of horizontal edge counts (hereinafter referred to as horizontal edge count information); and
Sum of vertical edge counts (hereinafter referred to as vertical edge count information).

### Correction of Toner Consumption Amount Using Edge Count Information

A method for correcting the toner consumption amount using the horizontal edge count information and vertical edge count information calculated in advance is now described.

As shown in FIG. 3, the calculation portion 54 includes a horizontal edge count ratio calculation portion 541 and a vertical edge count ratio calculation portion 542, which form a specific pixel obtainment portion together with the horizontal edge count portion 521 and the vertical edge count portion 522, and a correction factor calculation portion 543 as a correction factor obtainment portion. The calculation portion 54 receives pixel count information (the number of printing pixels), horizontal edge count information, and vertical edge count information from the control portion 52, performs predetermined calculation processing, and returns the calculated toner consumption amount correction factor to the control portion 52. Specifically, the horizontal edge count ratio calculation portion 541 calculates and obtains a horizontal edge count ratio as first pixel information on the basis of various types of information provided by the control portion 52. The horizontal edge count ratio is the ratio of the number of pixels having a difference in exposure brightness that is greater than or equal to a predetermined degree of difference relative to an adjacent pixel in the main scanning direction within the predetermined image range, to the number of printing pixels with an exposure brightness greater than or equal to the predetermined value. Similarly, the vertical edge count ratio calculation portion 542 calculates and obtains a vertical edge count ratio as second pixel information on the basis of various types of information provided by the control portion 52. The vertical edge count ratio is the ratio of the number of pixels having a difference in exposure brightness that is greater than or equal to a predetermined degree of difference relative to an adjacent pixel in the sub-scanning direction within a predetermined image range, to the number of printing pixels with an exposure brightness greater than or equal to a predetermined value. The correction factor calculation portion 543 calculates and obtains a correction factor for the toner consumption amount on the basis of the horizontal edge count ratio, the vertical edge count ratio, and the like. The control portion 52 has a toner consumption amount calculation portion 523 as a consumption amount obtainment portion, and corrects, using the correction factor provided by the correction factor calculation portion 543, a toner consumption amount based on pixel count information that does not use an edge count ratio, so as to calculate and obtains a toner consumption amount. The obtained toner consumption amount can be used to update information on the remaining amount of toner in the process cartridge in the image forming apparatus A, for example. The updated remaining toner amount information may be used to notify the host computer of the remaining toner amount, for example.

The horizontal edge count ratio calculation portion 541 calculates the horizontal edge count ratio=horizontal edge count information/pixel count information. The vertical edge count ratio calculation portion 542 calculates the vertical edge count ratio=vertical edge count information/pixel count information. The horizontal edge count ratio and vertical edge count ratio are defined as the proportion of adjacent pixels having a brightness difference greater than or equal to a certain degree in the horizontal or vertical direction to the counted pixels, in other words, the proportion of pixels that are counted as horizontal or vertical edges. Here, the horizontal edge count ratio and the vertical edge count ratio are parameters that are calculated independently, and are defined as parameters that simply indicate the type of the image included in the printing information.

When both the horizontal edge count ratio and the vertical edge count ratio are large, it can be assumed that the image is composed of one or several isolated pixels. Also, when the horizontal edge count ratio is large but the vertical edge count ratio is small, it can be assumed that the image resembles what is known as a vertical line pattern. Conversely, when the vertical edge count ratio is large and the horizontal edge count ratio is small, it can be assumed that the image resembles a horizontal line pattern. Furthermore, when both the horizontal edge count ratio and the vertical edge count ratio are small, it can be assumed that the effective pixels are adjacent to each other, that is, the image resembles a solid image.

The above description illustrates that, even with the same pixel count, the use of parameters of the horizontal edge count ratio and the vertical edge count ratio in combination allows for the obtainment of information such as whether the image resembles a collection of isolated dots, resembles a line image, or resembles a solid image in the predetermined printing range.

With an image forming apparatus that uses an electrophotographic system, it is mandatory to measure the consumption amount using a printing image and a printing mode that are specified by a standard. For example, the pixel count for calculating the consumption amount in a state in which a predetermined printing image is printed in a predetermined printing mode is standardized as 1, and consumption amounts are evaluated and calculated for various image patterns. This makes it possible to create a table showing possible consumption amounts resulting from a change in the edge count ratio, in other words, correction factors.

Accordingly, when the correction factor for the consumption amount can be determined according to the values of the vertical edge count ratio and the horizontal edge count ratio, the consumption amount can be calculated more accurately than with simple pixel counting, using a relatively simple technique.

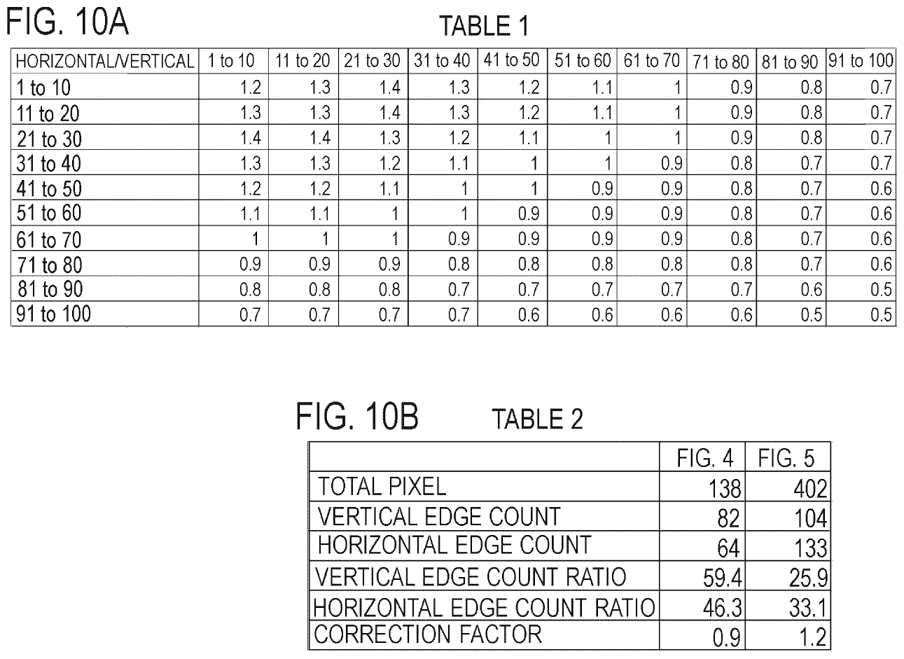

The horizontal edge count ratio and the vertical edge count ratio used herein are parameters that are calculated independently. As described above, a table corresponding to isolated dots, line image, and solid image, such as Table 1 of FIG. 10A, is prepared. Table 1 defines toner consumption amount correction factors determined according to the correspondence relationship between the horizontal edge count ratios as the first pixel information and the vertical edge count ratios as the second pixel information.

As can be understood from the above description, the method for calculating the correction amount in this embodiment does not calculate the consumption amount for each pixel. The method of this embodiment is characterized in that it calculates the horizontal edge count ratio and the vertical edge count ratio for the pixel count obtained from printing information for a certain range, and then uses Table 1 of FIG. 10A corresponding to each value to calculate a correction amount for the pixel count.

The present invention provides a toner consumption amount measurement method that uses a pixel count and can accommodate a variety of image patterns through a relatively simple technique without requiring complex processing even in the current environment of increasing speed and resolution. According to the present invention, the use of horizontal edge count and vertical edge count, which are parameters that can be calculated relatively easily and are independent of each other, facilitates the determination on whether the pixels are arranged in a dispersed manner, or arranged collectively. This allows a correction factor to be derived appropriately according to a change in the consumption amount caused by variations of printing patterns, thereby improving the accuracy of consumption amount calculation using the pixel count.

### Examples of Actual Application

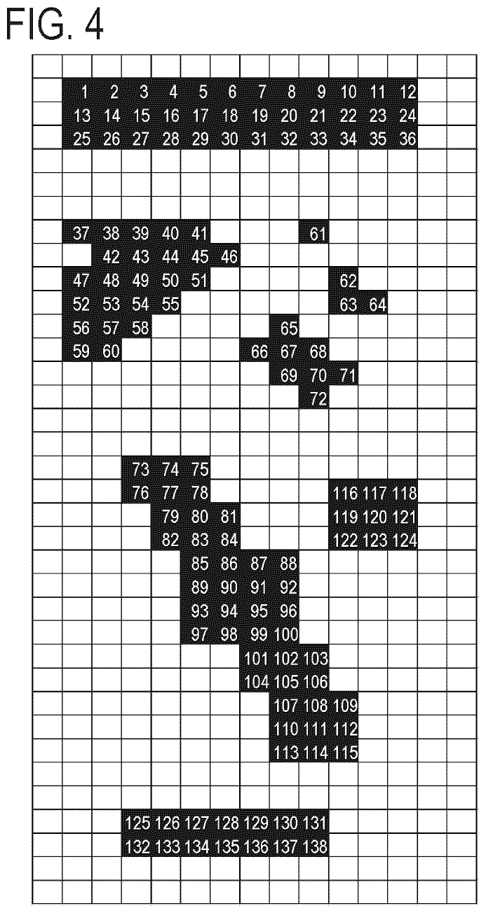

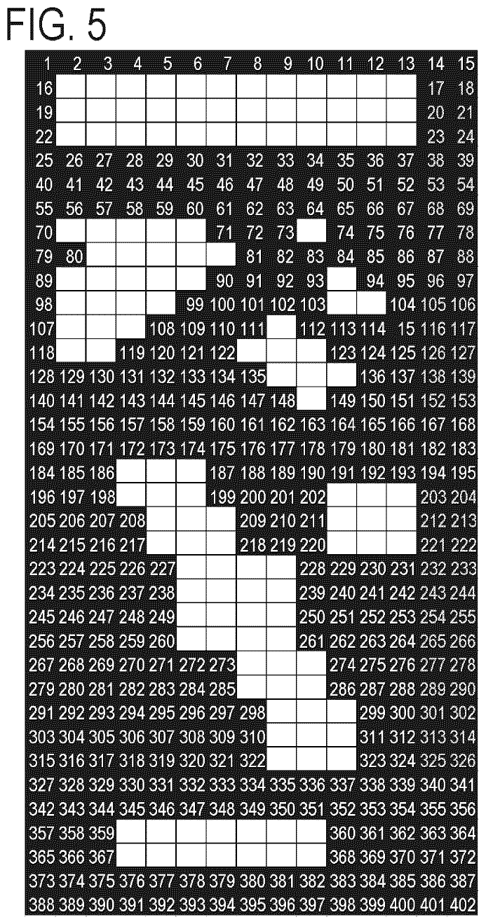

As simplified examples of a specific application of the embodiment of the present invention, two exemplary patterns, each of which is a binary image of 15 pixels×36 pixels=540 pixels, are separately illustrated in FIGS. 4 and 5.

In the illustration herein, pixels that are to be indicated blank are shown in white, and pixels that are to be indicated as printing portions are shown in black. For purposes of illustration, each of the pixels to be indicated as printing portions is numbered for the reference of the pixel.

The pattern shown in FIG. 4 has pixel count information of 138 pixels, which are counted as printing portions. At the same time, as pixels with both vertical and horizontal edges, the pattern of FIG. 4 has a total of 43 pixels, including 1, 12, 25, 36, 37, 41, 46, 47, 51, 55, 58-66, 68, 69, 71-73, 76, (some parts omitted), 125, 131, 132, and 138. Similarly, pixels with only vertical edges are 39 pixels in total, including 2 to 11 and 26 to 35, for example, while pixels with only horizontal edges are 21 pixels in total, including pixels 13 and 24, for example. Thus, in the pattern shown in FIG. 4, the vertical edge count, which is the integrated value of pixels with vertical edges, is 82, obtained by adding 43 and 39, and the horizontal edge count, which is the integrated value of pixels with horizontal edges, is 64, obtained by adding 43 and 21.

Accordingly, the vertical edge count ratio is 82/138=59.4%, and the horizontal edge count ratio is 64/138=46.3%. Using Table 1 of FIG. 10A, the correction factor corresponding to a vertical edge count ratio of 59.4% and a horizontal edge count ratio of 46.3% is 0.9.

The pattern shown in FIG. 5 has pixel count information of 402 pixels, which are counted as printing portions. In a similar manner as the pattern of FIG. 4, there are a total of 26 pixels having both vertical and horizontal edges, a total of 78 pixels having only vertical edges, and a total of 107 pixels having only horizontal edges. Similarly, the vertical edge count of the pattern shown in FIG. 5 is 104 and the horizontal edge count is 133, so that the vertical edge count ratio is calculated as 104/402=25.9%, and the horizontal edge count ratio is calculated as 133/402=33.1%. The correction factor is 1.2 according to Table 1 of FIG. 10A. The above results are summarized in Table 2 of FIG. 10B.

The examples above illustrate the concept using 540-pixel images. However, in practical applications, a 600-dpi letter-sized binary image, for example, involves approximately 4000 pixels×6000 pixels. As such, a method for performing processing for each pixel according to the pattern of the brightness difference between adjacent pixels and accumulating the consumption amount for each pixel would result in complex processing, making it difficult to correct the toner consumption amount in real time. In other words, it will be difficult to quickly calculate the toner consumption amount and provide information on the remaining amount.

In contrast, the use of the method of the present embodiment is expected to significantly improve the accuracy simply by determining whether pixels of interest have a vertical or horizontal edge for counting and by using the integrated value as edge count information, as compared with the integrated value of a simple pixel count.

In the examples described above, the present invention is applied to a binary image defined by two gradations, 0 and 1. However, the present invention can also be applied to a multi-valued image with 256 gradations from 0 to 255. In one example, a vertical edge or a horizontal edge may be counted when there is a brightness difference that is greater than or equal to a certain degree (more specifically, a brightness difference of 240 or more, for example) relative to the pixels on the upper, lower, left, and right sides. The present invention is also effective in such a case of multi-valued images, since a technique similar to that described above can effectively correct the consumption amount using the edge count ratios for multi-valued images.

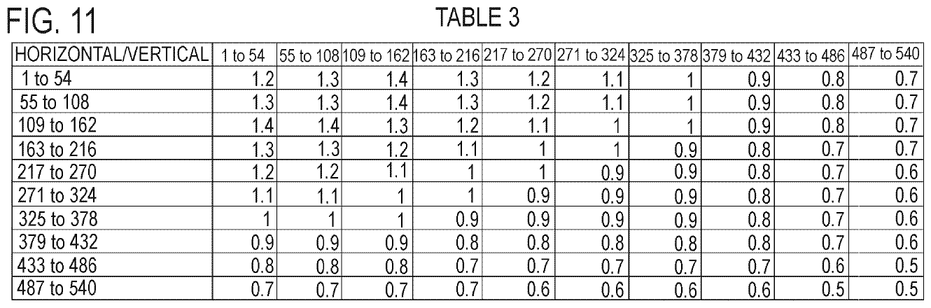

Also, in the example above, correction is performed using the vertical edge count ratio and horizontal edge count ratio as the first pixel information and the second pixel information. However, a correction table similar to Table 1 of FIG. 10A may also be prepared using the vertical edge count and horizontal edge count as they are. An example is shown in Table 3 of FIG. 11.

For a configuration that performs pixel counting always with a fixed printing image range, the consumption amount can be corrected in a similar manner using the absolute values of the horizontal edge count and vertical edge count, without normalizing them into edge count ratios as in Table 1 of FIG. 10A.

In the examples illustrated above, when α≠β, the same correction table is prepared for an instance in which the vertical edges and horizontal edges are α and β, and an instance in which the vertical edges and horizontal edges are β and α. However, it is also possible to prepare a correction table with different weighting. When consideration is given to sweeping or other phenomenon, a degree of consumption amount correction may be increased for vertical edges.

Furthermore, instead of using a fixed correction table such as Table 1 of FIG. 10A, multiple tables may be prepared according to the environment in which the image forming apparatus is installed. Alternatively, the correction table may be replaced when the toner is replenished. That is, the present invention is not limited to the example shown in this embodiment, and multiple variations are possible.

As described above, it has been demonstrated that appropriate correction processing can be achieved for the consumption amount using a pixel count by a relatively simple technique of determining whether pixels of interest have an edge.

### Second Embodiment

An image forming apparatus of a second embodiment according to the present invention is now described. In the second embodiment, the same reference numerals are given to the same configurations as the first embodiment, and the description thereof is omitted. The features of the second embodiment that are not specifically described are the same as those in the first embodiment.

In the first embodiment, a vertical edge is counted when either side in the up-down direction is blank, and a horizontal edge is counted when either side in the right-left direction is blank. In contrast, the second embodiment is significantly different from the first embodiment in that it distinguishes between the case where only one of the upper and lower sides is blank and the case where both of the upper and lower sides are blank.

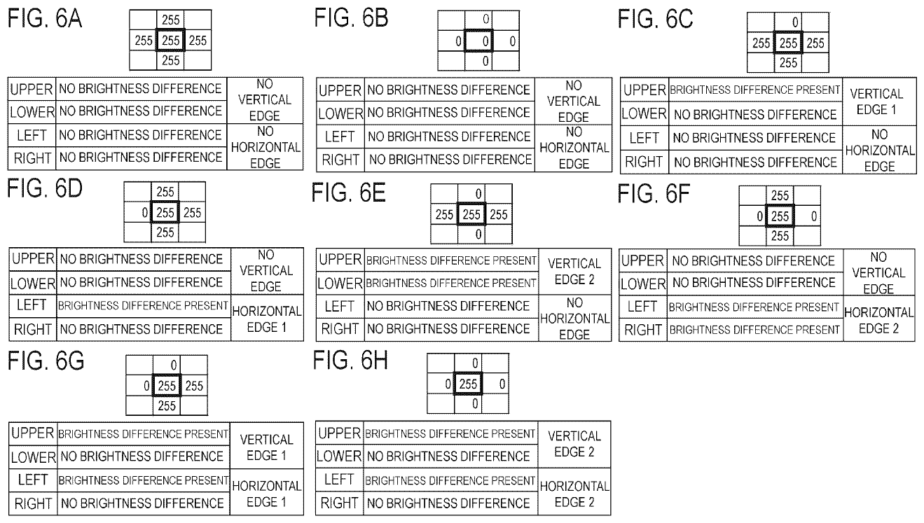

In comparison with FIGS. 1A to 1G used in the description of the first embodiment, counting of vertical edges and horizontal edges in this embodiment is now described with reference to FIGS. 6A to 6H.

In each of FIGS. 6A to 6H, the pixel of interest is the pixel enclosed by a heavy line.

In FIG. 6A, the brightness value of the pixel of interest is 255, and the adjacent pixels on the upper, lower, left, and right sides are also 255, so that the brightness difference between them is 0. Neither vertical nor horizontal edges are counted.

In FIG. 6B, the brightness value of the pixel of interest is 0, and the adjacent pixels on the upper, lower, left, and right sides are also 0, so that the brightness difference between them is 0. Neither vertical nor horizontal edges are counted. Pixels with a brightness value of 0 are not counted as pixels with an edge also in this embodiment.

In FIG. 6C, the brightness value of the pixel of interest is 255, the brightness value of the adjacent pixel on the upper side is 0, and the brightness values on the lower, left, and right sides are 255, so that a vertical edge is counted, and a horizontal edge is not counted.

In FIG. 6D, the brightness value of the pixel of interest is 255, the brightness value of the adjacent pixel on the left is 0, and the brightness values on the upper, lower, and right sides are 255, so that a vertical edge is not counted, and a horizontal edge is counted.

In FIG. 6E, the brightness value of the pixel of interest is 255, the brightness values of the adjacent pixels on the upper and lower sides are 0, and the brightness values on the left and right sides are 255, so that two vertical edges are counted on the upper and lower sides, and a horizontal edge is not counted.

In FIG. 6F, the brightness value of the pixel of interest is 255, the brightness values of the adjacent pixels on the right and left sides are 0, and the brightness values on the upper and lower sides are 255, so that two horizontal edges are counted on the left and right sides, and a vertical edge is not counted.

In FIG. 6G, the brightness value of the pixel of interest is 255, the brightness values of the adjacent pixels on the upper and left sides are 0, and the brightness values on the lower and right sides are 255, so that both one vertical edge and one horizontal edge are counted.

In FIG. 6H, the brightness value of the pixel of interest is 255, and the brightness values of the adjacent pixels on the upper, lower, right, and left sides are all 0, so that two horizontal edges and two vertical edges are counted.

In this embodiment, relative to one pixel, the upper and lower sides can be vertical edges, and the left and right sides can be horizontal edges. As such, when there are edges on both sides, that is, when both the upper and lower sides, or both the left and right sides are counted as edges, the counted number is doubled so that the edge count is 2. In contrast, when only one side is an edge, that is, only one of the upper and lower sides, or only one of the left and right sides is an edge, the edge count is 1. In this manner, applying or changing weighting according to the state of edges is expected to further facilitate distinguishing a pattern that resembles isolated pixels.

Accordingly, for the effective pixel count, the vertical edge count ratio=the vertical edge count/(2×pixel count number), and the horizontal edge count ratio=the horizontal edge count/(2×pixel count number). As the count ratio, an edge count ratio in the range of 1 to 100% as shown in Table 1 of FIG. 10A may be applied.

Descriptions of the configuration of the image forming apparatus itself, the image signal processing portion, the control portion, the laser driving portion, the calculation portion, and the like, which are common to the first embodiment, will be omitted here.

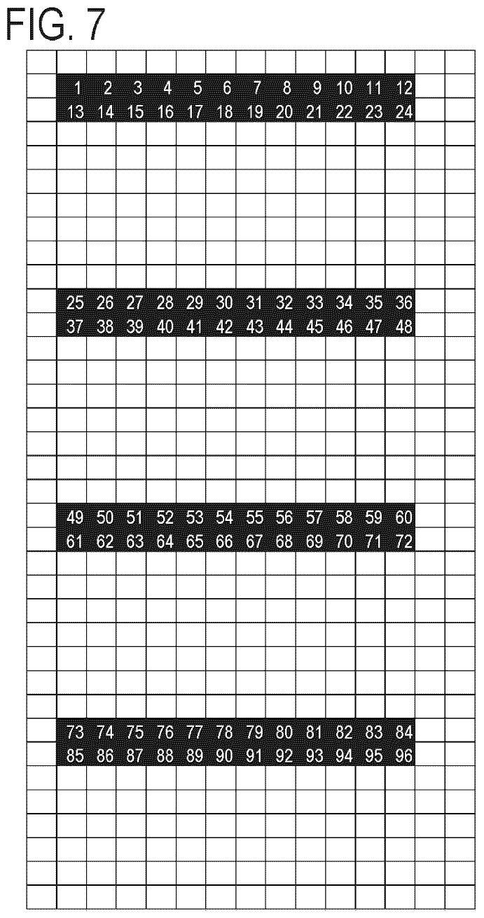

The advantageous effects of the present embodiment are also illustrated in comparison to the first embodiment using several binary images of 540 pixels. The following description refers to three patterns of images in FIGS. 7, 8, and 9, having the same pixel count (96 pixels).

FIG. 7 shows four printing portions each having 2 pixels×12 pixels. When the first embodiment is applied, the vertical edge count is 96 and the horizontal edge count is 16. With also the second embodiment, the vertical edge count is 96 and the horizontal edge count is 16.

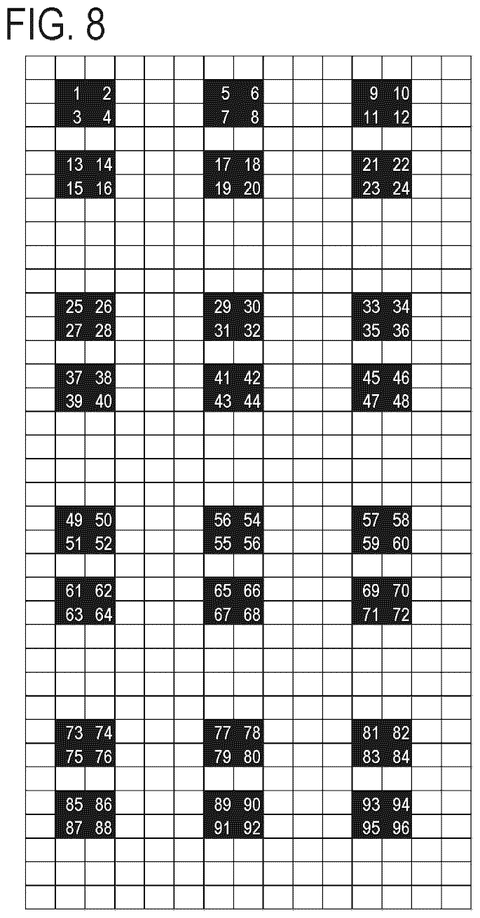

FIG. 8 shows 24 printing portions each having 2 pixels×2 pixels. When the first embodiment is applied, the vertical edge count is 96 and the horizontal edge count is 96. With also the second embodiment, the vertical edge count is also 96, and the horizontal edge count is also 96.

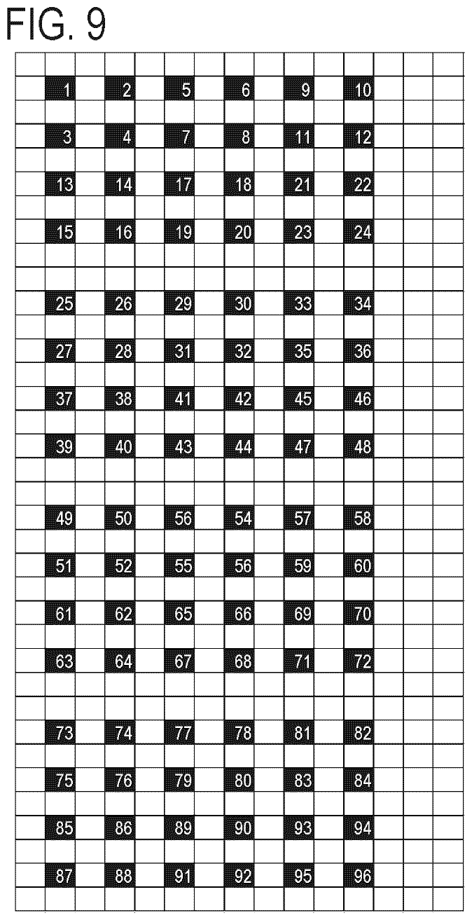

FIG. 9 shows 96 printing portions each having 1 pixel by 1 pixel. When the first embodiment is applied, the vertical edge count is 96 and the horizontal edge count is 96. With the second embodiment, the vertical edge count is 192, and the horizontal edge count is 192.

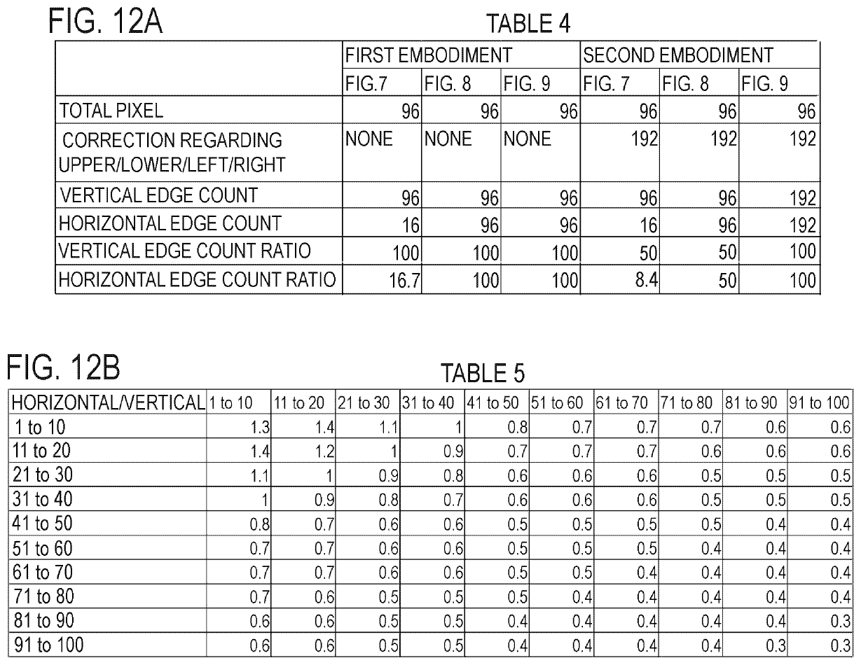

The edge count ratios are calculated as shown in Table 4 of FIG. 12A.

Table 1 of FIG. 10A can also be used for the second embodiment. However, for the printing image of FIG. 8, in the first embodiment, both the vertical edge count ratio and the horizontal edge count ratio are 100%, resulting in a correction factor of 0.5.

In contrast, in the second embodiment, the vertical edge count ratio and the horizontal edge count ratio are 50%, resulting in a correction factor of 1. This is undesirable because the actual condition that small pixels involving shallow electrostatic latent image patterns result in less toner consumption may not be reflected.

As such, in this embodiment, as an example, Table 5 of FIG. 12B, which differs from Table 1 of FIG. 10A, is prepared. This is a mode configured by taking into consideration the possibility that one pixel may have a maximum of two edges in both the up-down direction and the right-left direction. That is, since the number of vertical edges and the number of horizontal edges can each take 0, 1, or 2 for one pixel, the maximum numbers of vertical edges and horizontal edges are two times the effective pixel count.

With the edge counting of the first embodiment, the vertical edge count is 1 in both FIGS. 6C and 6E, and the horizontal edge count is 1 in both FIGS. 6D and 6F. In contrast, with the edge counting of the present embodiment, the vertical edge count in FIG. 6E is 2, and the horizontal edge count in FIG. 6F is 2.

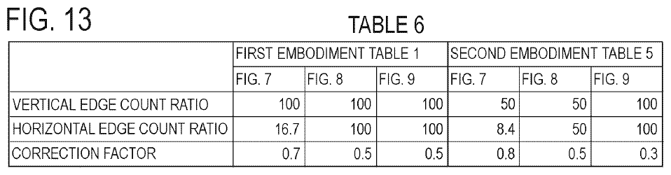

Table 6 of FIG. 13 shows the correction factors obtained by applying Table 1 of FIG. 10A of the first embodiment and Table 5 of FIG. 12B of the second embodiment for each of the patterns of FIGS. 7, 8, and 9.

In the first embodiment, the pattern in FIG. 8 and the pattern in FIG. 9 have the same edge count and therefore have the same correction factor. In contrast, in the present embodiment, since the edge counts are different values, the pattern of FIG. 8 and the pattern of FIG. 9 have different correction factors.

A table that assigns correction factors evenly for the edge count ratios, such as Table 5 of FIG. 12B, has the advantage that it can provide more detailed distinctions as compared with Table 1 of FIG. 10A for images with low printing ratios, such as those with many isolated dots. However, when there are many high-printing images such as solid images, the distinctions may be less detailed in comparison to Table 1 of FIG. 10A.

In order to achieve both of those, a correction table may be contemplated that is modified so as to have the same correction factors as Table 1 of FIG. 10A even for images with relatively high printing density, by further dividing the part of 1 to 50% of the edge count ratio in Table 5 of FIG. 12B.

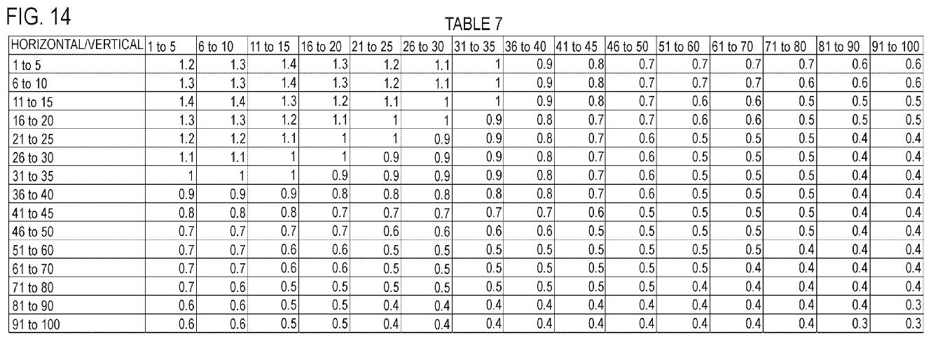

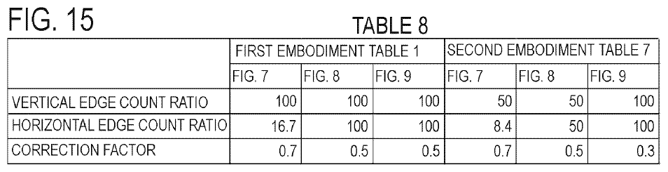

Table 7 of FIG. 14 is obtained by dividing the part of 1 to 50% of edge count ratio in Table 5 of FIG. 12B into 10 stages instead of 5 stages. Similarly, in this embodiment, the result shown in Table 8 of FIG. 15 is obtained when Table 7 of FIG. 14 is used instead of Table 5 in FIG. 12B.

From the above, it has been illustrated that even when edges on the upper, lower, left, and right sides of one pixel are considered independently, setting an appropriate correction table can achieve correction of the consumption amount using the pixel count.

The above embodiments can be combined with each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-214708, filed on Dec. 20, 2023, which is hereby incorporated by reference herein in its entirety.

What is claimed is:

1. An image forming apparatus comprising:
a photosensitive member;
a charging portion configured to charge the photosensitive member;
an exposure portion configured to perform exposure of a surface of the photosensitive member that is charged by the charging portion on the basis of image information, thereby forming an electrostatic latent image on the surface;
a developing portion configured to develop the electrostatic latent image with toner, thereby forming a toner image on the surface; and
a transfer portion configured to transfer the toner image to a recording material from the surface of the photosensitive member,
wherein the image forming apparatus includes:
a pixel number obtainment portion configured to obtain, from the image information, the number of printing pixels with brightness of the exposure that is at least a predetermined brightness among pixels within a predetermined image range;
a specific pixel obtainment portion configured to obtain first pixel information and second pixel information, the first pixel information being pixel information using an integrated value of the number of pixels having a difference in brightness of the exposure that is at least a predetermined degree of difference relative to an adjacent pixel in a main scanning direction within the predetermined image range, and the second pixel information being pixel information using an integrated value of the number of pixels having a difference in the brightness that is at least a predetermined degree of difference relative to an adjacent pixel in a sub-scanning direction within the predetermined image range;
a correction factor obtainment portion configured to obtain, on the basis of the first pixel information and the second pixel information, a correction factor for a toner consumption amount based on brightness of the exposure; and
a consumption amount obtainment portion configured to correct and obtain a toner consumption amount based on brightness of the exposure by using the correction factor obtained by the correction factor obtainment portion.

2. The image forming apparatus according to claim 1,
wherein the first pixel information is a ratio of the number of pixels having a difference in brightness of the exposure that is at least a predetermined degree of difference relative to an adjacent pixel in the main scanning direction within the predetermined image range, to the number of printing pixels with brightness of the exposure that is at least the predetermined brightness that is obtained by the pixel number obtainment portion, and
wherein the second pixel information is a ratio of the number of pixels having a difference in brightness of the exposure that is at least a predetermined degree of difference relative to an adjacent pixel in the sub-scanning direction within the predetermined image range, to the number of printing pixels with brightness of the exposure that is at least the predetermined brightness that is obtained by the pixel number obtainment portion.

3. The image forming apparatus according to claim 1,
wherein the first pixel information is the number of pixels having a difference in brightness of the exposure that is at least a predetermined degree of difference relative to an adjacent pixel in the main scanning direction within the predetermined image range, and
wherein the second pixel information is the number of pixels having a difference in brightness of the exposure that is at least a predetermined degree of difference relative to an adjacent pixel in the sub-scanning direction within the predetermined image range.

4. The image forming apparatus according to claim 1, wherein a correction factor obtained by the correction factor obtainment portion is set in advance according to a correspondence relationship between the first pixel information and the second pixel information.

5. The image forming apparatus according to claim 1,
wherein the first pixel information is counted by applying weighting to the number of pixels having a difference in the brightness that is at least a predetermined degree of difference relative to pixels on both sides in the main scanning direction, relative to the number of pixels having a difference in the brightness that is at least a predetermined degree of difference relative to a pixel only on one side in the main scanning direction, and
wherein the second information is counted by applying weighting to the number of pixels having a difference in the brightness that is at least a predetermined degree of difference relative to pixels on both sides in the sub-scanning direction, relative to the number of pixels having a difference in the brightness that is at least a predetermined degree of difference relative to a pixel only on one side in the sub-scanning direction.

6. The image forming apparatus according to claim 5, wherein the weighting implements counting by doubling numbers.
